(19) United States
(12) Patent Application Publication
(10) Pub. No.: US 2007/0024710 A1
(43) Pub. Date: Feb. 1, 2007

(54) Monitoring system, monitoring apparatus, monitoring method and program therefor

(75) Inventor: Satoshi Nakamura, Saitama (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/489,601

(22) Filed: Jul. 20, 2006

(30) Foreign Application Priority Data
Jul. 27, 2005 (JP) 2005-217933

(51) Int. Cl. H04N 7/18; H04N 11/04

(52) U.S. Cl. 348/143; 375/240.01

(57) ABSTRACT

A monitoring system being capable of monitoring an important monitoring region at low cost is provided. The monitoring system according to the present invention includes: a first image capturing section for capturing a moving image in a first monitoring region; a second image capturing section for capturing a moving image in a second monitoring region adjacent to the first monitoring region in synchronism with an image capturing operation by the first image capturing section in the first monitoring region; a composite image generating section for adjusting a position at which a first frame image constituting a moving image captured by the first image capturing section and a second frame image constituting a moving image captured by the second image capturing section are combined based on the relative positional relationship between the first monitoring region captured by the first image capturing section and the second monitoring region captured by the second image capturing section; and a moving image storage section for storing the composite image generated by the composite image generating section as the frame image constituting the moving image in a partial monitoring region including at least a part of the first monitoring region and the second monitoring region.

### CROSS REFERENCE

The present application relates to and claims priority from a Japanese Patent Application No. 2005-217933 filed in Japan on Jul. 27, 2005, the contents of which are incorporated herein by reference for all purpose.

### BACKGROUND OF THE INVENTION

1. Field of the Invention

The present invention relates to a monitoring system, a monitoring apparatus, a monitoring method, and a program therefor. Particularly, the present invention relates to a monitoring system, a monitoring apparatus, a monitoring method for capturing a moving image in a monitoring region, and a program for the monitoring system.

2. Related Art

Conventionally, a system has been known, for storing a subject with a normal state as a reference image, comparing a captured image with the reference image for each corresponding pixel, setting a compression ratio of an image compression processing to relatively low and recording the same on a recording medium when it is confirmed that the captured image has been changed as the result of the comparison, but alternatively when it is confirmed that the captured image has not been changed, setting the compression ratio of the image compression processing to relatively high and recording the same on the recording medium, as disclosed in Japanese Patent Application Publication No. 2002-335492.

However, in such as the above-described conventional system, which is a system for capturing an image in the monitoring region, the resolution of the captured image is reduced as enlarging the range of the subject, so that it is difficult to identify whether the person shown in the captured image is a suspicious person due to the reduced resolution. Meanwhile, if an image capturing apparatus with the high resolution is used, the cost of the system may be increased.

### SUMMARY OF THE INVENTION

Thus, it is an object of the present invention to provide a monitoring system, a monitoring apparatus, a monitoring method and a program therefore which are capable of solving the problem accompanying the conventional art. The above and other objects can be achieved by combining the features recited in independent claims. Then, dependent claims define further effective specific example of the present invention.

A first aspect of the present invention provides a monitoring system. The monitoring system includes: a first image capturing section for capturing a moving image in a first monitoring region; a second image capturing section for capturing a moving image in a second monitoring region adjacent to the first monitoring region in synchronism with an image capturing operation by the first image capturing section in the first monitoring region; a composite image generating section for adjusting a position at which a first frame image constituting the moving image captured by the first image capturing section and a second frame image constituting the moving image captured by the second image capturing section are combined to generate a composite image; and a moving image storage section for storing the composite image generated by the composite image generating section as a frame image constituting the moving image in a partial monitoring region including at least a part of the first monitoring region and the second monitoring region.

The monitoring system may further include an overlapped monitoring region identifying section for identifying an overlap monitoring region over which the first monitoring region captured by the first image capturing section and the second monitoring region captured by the second image capturing section are overlapped by matching the first frame image captured by the first image capturing section with a second frame image captured by the second image capturing section at the same time the first image capturing section captures the first frame image, and a monitoring region position calculating section for calculating a relative positional relationship between the first monitoring region captured by the first image capturing section and second monitoring region captured by the second image capturing section based on the overlapped monitoring region identified by the overlapped monitoring region identifying section. The composite image generating section may adjust the position at which the first frame image and the second frame image are combined based on the relative positional relationship between the first monitoring region and the second monitoring region calculated by the monitoring region position calculating section to generate the composite image.

The monitoring system may further include a trimming section for trimming the composite image generated by the composite image generating section with an aspect ratio equal to that of the first frame image captured by the first image capturing section or the second frame image captured by the second image capturing section and extracting a partial monitoring region image. The moving image storage section may store the partial monitoring region image extracted by the trimming section as the frame image constituting the moving image in the partial monitoring region.

The monitoring system may further include a trimming section for trimming the composite image generated by the composite image generating section with an aspect ratio equal to that of the frame image constituting the moving image reproduced by an external image reproducing apparatus and extracting a partial monitoring region image. The moving image storage section may store the partial monitoring region image extracted by the trimming section as the frame image constituting the moving image in the partial monitoring region.

The monitoring system may further include a moving image compressing section for compressing the plurality of partial monitoring region images extracted by the trimming section as the frame images constituting the moving image. The moving image storage section may store the plurality of partial monitoring region images compressed by the moving image compressing section as the frame images constituting the moving image in the partial monitoring region.

The monitoring system may further include an image processing section for alternately processing the first frame image read from a plurality of light receiving elements included in the first image capturing section and a plurality of light receiving elements read from the second image capturing section and storing the same in the memory.

The image processing section may include an AD converting section for alternately converting the first frame image read from the plurality of light receiving elements included in the first image capturing section and the second frame image read from the plurality of light receiving elements included in the second image capturing section to digital data. The composite image generating section may adjust the position at which the first frame image converted to the digital data by the AD converting section and the second frame image converted to the digital data by the AD converting section to generate a composite image.

The image processing section may include an image data converting section for alternately converting image data for the first frame image read from the plurality of light receiving elements included in the first image capturing section and image data for the second frame image read from the plurality of light receiving elements included in the second image capturing section to display image data. The composite image generating section may adjust the position at which the first frame image converted to the display image data by the image data converting section and the second frame image converted to the display image data by the image data converting section are combined to generate the composite image.

A second aspect of the present invention provides a monitoring apparatus. The monitoring apparatus includes: a first image capturing section for capturing a moving image in a first monitoring region; a second image capturing section for capturing a moving image in a second monitoring region adjacent to the first monitoring region in synchronism with an image capturing operation by the first image capturing section in the first monitoring region; a composite image generating section for adjusting a position at which a first frame image constituting the moving image captured by the first image capturing section and a second frame image constituting the moving image captured by the second image capturing section based on a relative positional relationship between the first monitoring region captured by the first image capturing section and the second monitoring region captured by the second image capturing section to generate a composite image; and a moving image storage section for storing the composite image generated by the composite image generating section as a frame image constituting the moving image in a partial monitoring region including at least a part of the first monitoring region and the second monitoring region.

A third aspect of the present invention provided a monitoring method. The monitoring method includes the steps of: capturing a moving image in a first monitoring region; capturing a moving image in a second monitoring region adjacent to the first monitoring region in synchronism with an image capturing operation in the first image capturing step; adjusting a position at which a first frame image constituting the moving image captured in the first image capturing step and a second frame image constituting the moving image captured in the second image capturing step to generate the composite image; storing the composite image generated in the composite image generating step as a frame image constituting the moving image in a partial monitoring region including at least a part of the first monitoring region and the second monitoring region.

A fourth aspect of the present invention provides a program for a monitoring system for capturing an moving image. The program operates the monitoring system to function as: a first image capturing section for capturing a moving image in a first monitoring region; a second image capturing section for capturing a moving image in a second monitoring region adjacent to the first monitoring region in synchronism with an image capturing operation by the first image capturing section in the first monitoring region; a composite image generating section for adjusting a position at which a first frame image constituting the moving image captured by the first image capturing section and a second frame image constituting the moving image captured by the second image capturing section are combined to generate a composite image; and a moving image storage section for storing the composite image generated by the composite image generating section as a frame image constituting the moving image in a partial monitoring region including at least a part of the first monitoring region and the second monitoring region.

Here, all necessary features of the present invention are not listed in the summary of the invention. The sub-combinations of the features may become the invention.

According to the present invention, the monitoring system being capable of monitoring an important monitoring region at low cost can be provided.

### BRIEF DESCRIPTION OF THE DRAWINGS

FIG. 1 shows an example of the environment of the usage of a monitoring system 100;

FIG. 2 is a block diagram of the operation in a trimming mode;

FIG. 3 shows an example of an image capturing process in a monitoring region;

FIG. 4 is an example of a processing to trim a characteristic region image from a composite image;

FIG. 5 is an example of a processing to match an image capturing condition;

FIG. 6 is a block diagram of the operation in a connecting mode;

FIG. 7 shows an example of a frame image generated in the connecting mode;

FIG. 8 is a flow chart to select an operation mode to generate a frame image; and

FIG. 9 shows an example of a hardware configuration of a monitoring apparatus 110.

### DETAILED DESCRIPTION OF THE INVENTION

Hereinafter, the present invention will now be described through preferred embodiments. The embodiments do not limit the invention according to claims and all combinations of the features described in the embodiments are not necessarily essential to means for solving the problems of the invention.

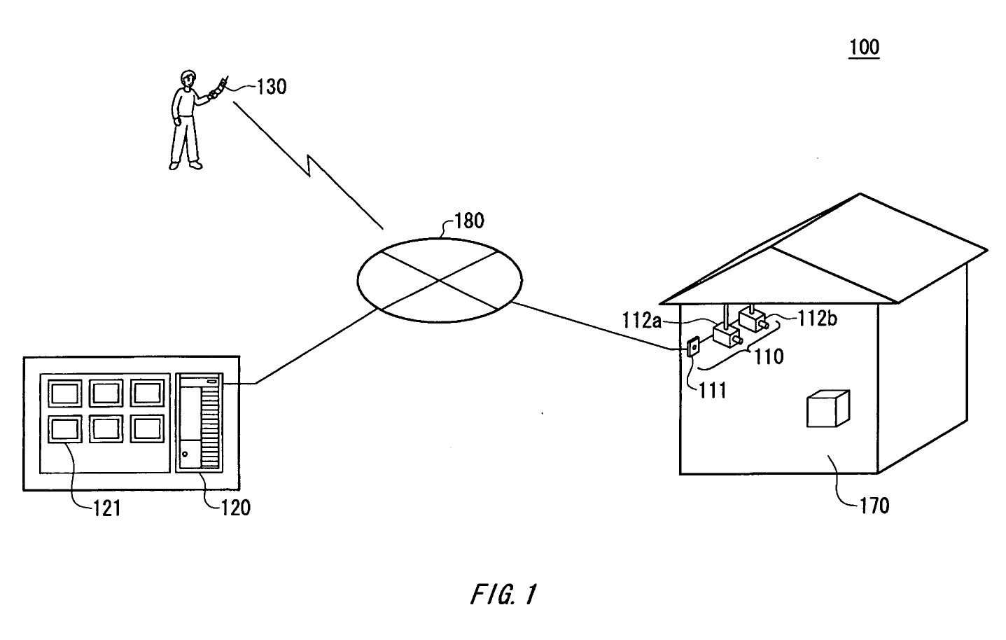

FIG. 1 shows an example of the environment of the usage of a monitoring system 100. The monitoring system 100 includes a monitoring apparatus 110, an image reproducing apparatus 120 and a portable unit 130. The monitoring apparatus 110 captures a monitoring region 170, generates a frame image for a moving image and transmits the same to the image reproducing apparatus 120 provided in a monitoring center and the portable unit 130 held by a manager of the monitoring region 170. The monitoring apparatus 110 includes a plurality of cameras 112a and 112b (hereinafter generally referred to as 112) for capturing a moving image in the monitoring region 170, and an image generating apparatus 111 for sequentially receiving image capturing data from the cameras 112a and 112b and converting the same to image data.

The cameras 112a and 112b capture the different image capturing ranges in the image capturing monitoring region 170. The image capturing regions captured by the cameras 112a and 112b may be at least partially overlapped. Then, the image generating apparatus 111 identifies an overlapped capturing region captured by both of the camera 112a and the camera 112b and combines the image region other than the overlapped image capturing region by the camera 112b and the image captured by the camera 112a to generate a composite image. Then, the image generating apparatus 111 trims an image region including a person and an image region on which a moving subject is shown from the composite image to generate one frame image, and then transmits the same to the image reproducing apparatus 120. At this time, the monitoring apparatus 110 trims the image region with an aspect ratio for capturing by the camera 112a or 112b, or an aspect ratio of an image to be displayed on a display device 121 such as a monitor by the image reproducing apparatus 120.

As for the frame images captured by the cameras 112a and 112b, the image capturing condition for the camera 112a for capturing the important partial region as a monitoring target such as the partial region including a person and the partial region including a moving object may be matched with the image capturing condition for another camera 112b to capture the frame images.

The monitoring apparatus 110 may have not only the above-described trimming mode in which the important partial region is trimmed from the composite image obtained by combining the images captured by the plurality of cameras 112 to generate a frame image but also a connecting mode in which the plurality of important partial regions as the monitoring target are trimmed from each of the frame images captured by the plurality of cameras 112, and the trimmed partial regions are connected each other into one frame image to generate one frame image. Here, in the connecting mode, a frame image with the aspect ratio equal to that of the frame image in the trimming mode may be generated.

The above described monitoring system 100 can effectively monitor the monitoring region over a wide range using the plurality of cameras 112 with a low resolution and a low price without a high-resolution camera. For example, when it needs to monitor an oblong monitoring region, a monitoring region with the resolution appropriate for each of the monitoring region can be obtained by arranging the plurality of cameras 112 in a lateral direction. Additionally, the shared image generating apparatus 111 processes the image capturing data captured by the plurality of cameras, so that moving images can be generated at lower cost in comparison with the case that each of the cameras 112 processes the image.

Here, the monitoring apparatus 110 may transmit the captured image to the image reproducing apparatus 120 or the portable unit 130 through a communication line 180 such as Internet. Additionally, the image reproducing apparatus 120 may be an apparatus such as a computer being capable of receiving a moving image and reproducing the same. Additionally, the portable terminal 130 may be a hand-held terminal such as a cellular phone and a PDA. The image reproducing apparatus 120 may be located at a monitoring center far from the monitoring region 170 and also may be located adjacent to the monitoring region 170.

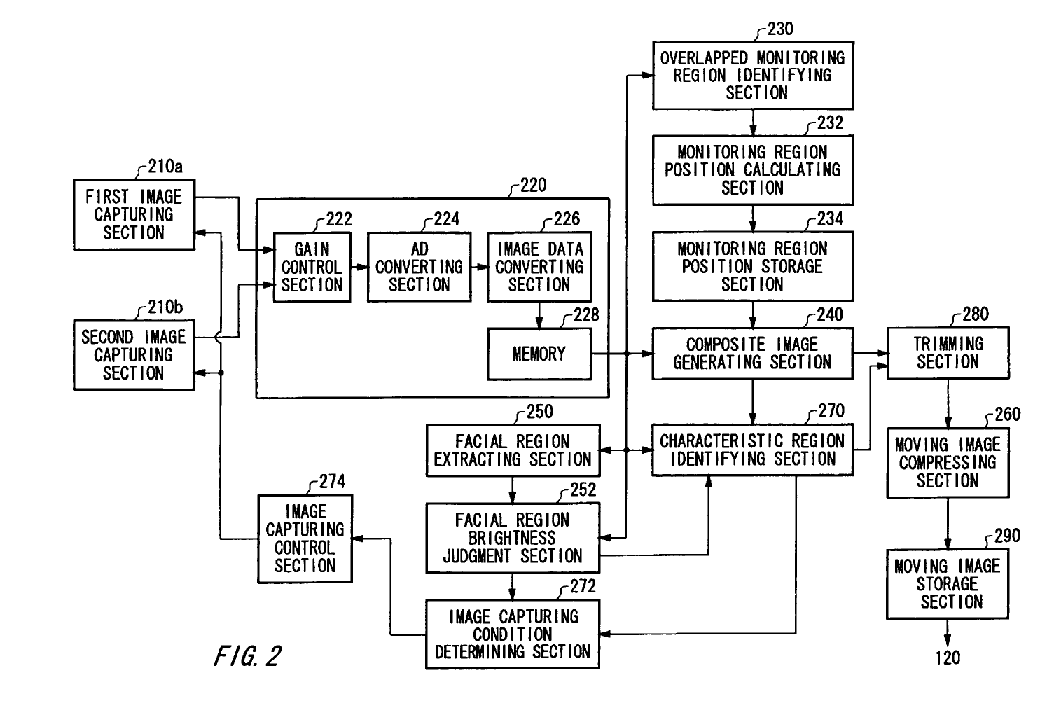

FIG. 2 is a block diagram of the operation in a trimming mode. The monitoring system 100 includes a first image capturing section 210a, a second image capturing section 210b, an image processing section 220, an overlapped monitoring region identifying section 230, a monitoring region position calculating section 232, a monitoring region position storage section 234, a composite image generating section 240, a facial region extracting section 250, a facial region brightness judgment section 252, a moving image compressing section 260, a characteristic region identifying section 270, an image capturing condition determining section 272, an image control section 274, a trimming section 280 and a moving image storage section 290. The image processing section 220 includes a gain control section 22, an AD converting section 224, an image data converting section 226 and a memory 228. Here, the cameras 112a and 112b described with reference to FIG. 1 may operate as the first image capturing section 210a and a second image capturing section 210b, respectively. The image generating apparatus 111 described with reference to FIG. 1 may operate as the image processing section 220, the overlapped monitoring region identifying section 230, the monitoring region position calculating section 232, a monitoring region position storage section 234, a composite image generating section 240, a facial region extracting section 250, a facial region brightness judgment section 252, a moving image compressing section 260, a characteristic region identifying section 270, an image capturing condition determining section 272, an image capturing control section 274, a trimming section 280 and a moving image storage section 290.

The first image capturing section 210a captures a moving image in a first monitoring region. The second image capturing section 210b captures a moving image in a second monitoring region adjacent to the first monitoring region in synchronism with an image capturing operation by the first image capturing section in the first monitoring region. For example, the second image capturing section 210b captures the second monitoring region at a timing the same as that of the image capturing operation of the first image capturing section 210a. Specifically, the first image capturing section 210a and the second image capturing section 210b may receive light from a subject through a plurality of light receiving elements such as a CCD to generate a first frame image and a second frame image for the moving image, respectively.

Specifically, the monitoring region position storage section 234 stores a relative positional relationship between the first monitoring region captured by the first monitoring section 210a and the second monitoring region captured by the second image capturing section 210b. Then, the composite image generating section 240 adjusts the position at which a first frame image and a second frame image are combined based on the relative positional relationship between the first monitoring region and the second monitoring region stored in the monitoring region position storage section 234 to generate the composite image.

The composite image generating section 240 adjusts the position at which the first frame image constituting the moving image captured by the first image capturing section 210a and the second frame image constituting the moving image captured by the second image capturing section 210b, respectively based on the relative positional relationship between the first monitoring region captured by the first image capturing section 210a and the second monitoring region captured by the second image capturing section 210b to generate a composite image. Then, the moving image storage section 290 stores the composite image generated by the composite image generating section 240 as a frame image constituting the moving image in a partial monitoring region including at least a part of the first monitoring region and the second monitoring region. Thereby the monitoring region 170 with the wide range can be monitored by the plurality of image capturing apparatus.

The overlapped monitoring region identifying section 230 identifies an overlapped monitoring region over which the first monitoring region captured by the first image capturing section 210a and the second monitoring region captured by the second image capturing section 210a are overlapped by matching the first frame image captured by the first image capturing section 210a with the second frame image captured by the second image capturing section 210b at the same time the first image capturing section 210a captures the first frame image. The monitoring region position calculating section 232 calculates the relative positional relationship between the first monitoring region captured by the first image capturing section 210a and the second monitoring region captured by the second image capturing section 210b based on the overlapped monitoring region identified by the overlapped monitoring region identifying section 230. Then, the monitoring region position storage section 234 stores the relative positional relationship between the first monitoring region captured by the first image capturing section 210a and the second monitoring region captured by the second image capturing section 210b calculated by the monitoring region position calculating section 232.

Then, the composite image generating section 240 adjusts the position at which the first frame image and the second frame image are combined based on the relative positional relationship between the first monitoring region and the second monitoring region calculated by the monitoring region position calculating section 232 to generate a composite image. Specifically, the composite image generating section 240 generates a composite image based on the relative relationship between the first monitoring region and the second monitoring region calculated by the monitoring region position calculating section 232, which is stored in the monitoring region position storage section 234.

Here, the monitoring region position storage section 234 may previously store the relative positional relationship between the first monitoring region captured by the first image capturing section 210a and the second monitoring region captured by the second image capturing section 210b. Additionally, the overlapped monitoring region identifying section 230 may regularly identify the overlapped monitoring region based on the first frame image captured by the first image capturing section 210a and the second frame image captured by the second image capturing section 210b. Then, the monitoring region position calculating section 232 may regularly calculate the relative positional relationship between the first monitoring region captured by the first image capturing section 210a and the second monitoring region captured by the second image capturing section 210b based on the overlapped monitoring position regularly calculated by the overlapped monitoring region identifying section 230 and store the same in the monitoring region position storage section 234.

The trimming section 280 trims the composite image generated by the composite image generating section 240 with an aspect ratio equal to that of the first frame image captured by the first image capturing section 210a or the second frame image captured by the second image capturing section 210b and extracts a partial monitoring region image. Here, the trimming section 280 may trim the composite image generated by the composite image generating section 240 with an aspect ratio equal to that of the frame image constituting the moving image reproduced by an external image reproducing apparatus 120 and extract the partial monitoring region image.

Then, the moving image storage section 290 stores the partial monitoring region image extracted by the trimming section 280 as a frame image constituting the moving image in the partial monitoring region. The moving image compressing section 260 compresses a plurality of partial monitoring region images extracted by the trimming section 280 as the frame image constituting the moving image. For example, the moving image compressing section 260 compresses the plurality of partial monitoring region images based on the MPEG standard. Then, the moving image storage section 290 stores the plurality of partial monitoring region images compressed by the moving image compressing section 260 as the frame image constituting the moving image in the partial monitoring region. As described above, the monitoring apparatus 110 can generate the moving image in the partial region including the important subject as a monitoring target among the monitoring images captured in the wide range by the plurality of image capturing apparatus.

Here, the composite image generating section 240 may not actually generate a composite image but generate virtually a composite image. Specifically, the composite image generating section 240 may adjust the position at which the first frame image and the second frame image are combined based on the relative positional relationship between the first monitoring region and the second monitoring region calculated by the monitoring region position calculating section 232 to generate virtual composite image information obtained by associating information on the adjusted combining position with the first frame image and the second frame image. Then, the trimming section 280 may trim at least one of the first frame image and the second frame image based on the virtual composite image information generated by the composite image generating section 240 and extract the partial monitoring region image.

The image processing section 220 alternately processes the first frame image read from a plurality of light receiving elements included in the first image capturing section 210a and the second frame image read from a plurality of light receiving elements included in the second image capturing section 210b and stores the same in the memory 228. The gain control section 222 may be AGC (Automatic Gain Control), and converts a signal inputted from the first image capturing section 210a and the second image capturing section 210b in order that the level of the signal is appropriate for the subsequent signal processing. Then, the AD converting section 224 alternately converts the first frame image read from the plurality of light receiving elements included in the first image capturing section 210a and the second frame image read from the plurality of light receiving elements included in the second image capturing section 210b to digital data. Specifically, the signal of which the level is converted to the appropriate level by the gain control section 222 to digital data. Then, the composite image generating section 240 adjusts the position at which the first frame image converted to the digital data by the AD converting section 224 and the second frame image converted to the digital data by the AD converting section 224 are combined to generate the composite image.

Additionally, the image data converting section 226 alternately converts the image data for the first frame image read from the plurality of light receiving elements included in the first image capturing section 210a and the image data for the second frame image read from the plurality of light receiving elements included in the second image capturing section 210b to display image data. For example, the image data converting section 226 performs a transform processing such as a gamma correction on the amount of light received of the CCD which is converted to digital data by the AD converting section 224 to convert the same to the display image data. Then, the composite image generating section 240 adjusts the position at which the first frame image converted to the display image data by the image data converting section 226 and the second frame image converted to the display image data by the image data converting section 226 to generate a composite image.

As described above, the image capturing data captured by the first image capturing section 210a and the second image capturing section 210b is processed by means of the shared image processing section 220. Therefore, the cost of the monitoring apparatus 110 can be reduced in comparison with the case that each image capturing apparatus performs an image processing, respectively.

The characteristic region identifying section 270 identifies a characteristic region in a composite image by analyzing the composite image generated by the composite image generating section 240. Then, the trimming section 280 trims the characteristic region image being an image in the characteristic region identified by the characteristic region identifying region 270 from the composite image generated by the composite image generating section 240 and extracts the same. Then, the moving image storage section 290 stores the characteristic region image extracted by the trimming section 280 as a frame image constituting the moving image in the partial monitoring region including at least a part of the first monitoring region and the second monitoring region.

Specifically, the characteristic region identifying section 270 analyzes a plurality of continuous composite images generated by the composite image generating section 240 to identify a moving region in the composite image. For example, the moving region may be identified from the frame image previously captured. Then, the trimming section 280 trims the moving region image identified by the characteristic region identifying section 270 from the composite image generated by the composite image generating section 240 and extracts the same. Then, the moving image storage section 290 stores the moving region image extracted by the trimming section 280 as the frame image constituting the moving image in the partial monitoring region. Therefore, the monitoring apparatus 110 can appropriately monitor the image region including a moving subject as an important monitoring target region.

Additionally, the characteristic region identifying section 270 identifies a personal region in which a person is located in the composite image by analyzing the composite image generated by the composite image generating section 240. Then, the trimming section 280 trims a personal region image being an image of the personal region identified by the characteristic region identifying section 270 from the composite image generated by the composite image generating section 240 and extracts the same. Then, the moving image storage section 290 stores the personal region image extracted by the trimming section 280 as a frame image constituting the moving image in the partial monitoring region. Therefore, the monitoring apparatus 110 can appropriately monitor the image region including a person as an important monitoring target region.

Here, the trimming section 280 may trim the characteristic region image with an aspect ratio equal to that of the first frame image captured by the first image capturing section 210a and the second frame image captured by the second image capturing section 210b, or an aspect ratio equal to that of the frame image constituting the moving image reproduced by an external image reproducing apparatus 120 and extract the same. Then, the moving image storage section 290 stores the characteristic region image extracted by the trimming section 280 as the frame image constituting the moving image in the characteristic region. Therefore, the monitoring apparatus 110 can record the frame image with an aspect ratio appropriate for monitoring, on which the important monitoring target region is captured.

Additionally, the moving image compressing section 260 may compress the plurality of characteristic region image extracted by the trimming section 280 as a frame image constituting the moving image. The moving image storage section 290 may store the plurality of characteristic region images compressed by the moving image compressing section 260 as frame images constituting the moving image in the characteristic region.

The image capturing control section 274 matches the image capturing condition for the first image capturing section 210a and the image capturing condition for the second image capturing section 210b. Then, the composite image generating section 240 adjusts the position at which the first frame image constituting the moving image captured by the first image capturing section 210a and the second frame image constituting the moving image captured by the second image capturing section 210b under the same image capturing condition controlled by the image capturing control section 274 based on the relative positional relationship between the first monitoring region captured by the first image capturing section 210a and the second monitoring region captured by the second image capturing section 210b to generate a composite image. Here, the composite image generating section 240 adjusts the position at which the first frame image and the second frame image are combined based on the positional relationship between the first monitoring region and the second monitoring region as described above.

The characteristic region identifying section 270 identifies the characteristic region in the whole monitoring region 170 including the first monitoring region and the second monitoring region based on the moving images captured by the first image capturing section 210a and the second image capturing section 210b, respectively. Then, the image capturing condition determining section 272 determines the image capturing condition for the first image capturing section 210a and the second image capturing section 210b based on the image in the characteristic region identified by the characteristic region identifying section 270. Then, the image capturing control section 274 causes the first image capturing section 210a and the second image capturing section 210b to capture the moving image under the image capturing condition determined by the image capturing condition determining section 272.

Specifically, the characteristic region identifying section 270 identifies a moving region as the characteristic region based on the moving images captured by the first image capturing section 210a and the second image capturing section 210b, respectively. Here, the characteristic region identifying section 270 may identify the moving region which most dynamically moves when the whole monitoring region 170 includes a plurality of moving regions.

Then, the image capturing condition determining section 272 determines an exposure condition for the first image capturing section 210a and the second image capturing section 210b based on the first frame image for the first monitoring region captured by the first image capturing section 210a, which includes the moving region identified by the characteristic region identifying section 270. Then, the image capturing control section 274 causes the first image capturing section 210a and the second image capturing section 210b to capture the moving image under the exposure condition determined by the image capturing condition determining section 272.

The characteristic region identifying section 270 may identify the personal region in which a person is located as the characteristic region based on the moving images captured by the first image capturing section 210a and the second image capturing section 210b, respectively. Then, the image capturing condition determining section 272 determines the exposure condition for the first image capturing section 210a and the second image capturing section 210b based on the first frame image for the first monitoring region captured by the first image capturing section 210a, which includes the personal region identified by the characteristic region identifying section 270. Then, the image capturing control section 274 causes the first image capturing section 210a and the second image capturing section 210b to capture the moving image under the exposure condition determined by the image capturing condition determining section 272.

The characteristic region identifying section 270 identifies the largest personal region in the whole monitoring region 170 when the whole monitoring region 170 includes a plurality of personal regions. Then, the image capturing condition determining section 272 determines the exposure condition for the first image capturing section 210a and the second image capturing section 210b based on the first frame image obtained by capturing the first monitoring region by the first image capturing section 210a, which includes the personal region identified by the characteristic region identifying section 270. Then, the image capturing control section 274 causes the first image capturing section 210a and the second image capturing section 210b to capture the moving image under the exposure condition determined by the image capturing condition determining section 272. Therefore, the monitoring apparatus 110 can appropriately monitor a person such as an intruder into the monitoring region 170.

The facial region extracting section 250 extracts a facial region of a person in the whole monitoring region 170 base on the moving images captured by the first image capturing section 210a and the second image capturing section 210b, respectively. Then, the facial region brightness judgment section 252 judges the brightness of the facial region extracted by the facial region extracting section 250. Here, the characteristic region identifying section 270 identifies the personal region with the brightness within a predetermined brightness judged by the facial region brightness judgment section 252 when the whole monitoring region 170 includes a plurality of personal regions. Additionally, the characteristic region identifying section 270 may identify the brightest region judged by the facial region brightness judgment section 252 when the whole monitoring region 170 includes a plurality of personal regions.

Then, the image capturing condition determining section 272 determines the exposure condition for the first image capturing section 210a and the second image capturing section 210b based on the first frame image for the first monitoring region captured by the first image capturing section 210a, which includes the personal region identified by the characteristic region identifying section 270. Then, the image capturing control section 274 causes the first image capturing section 210a and the second image capturing section 210b under the exposure condition determined by the image capturing condition determining section 272. Here, the exposure condition may include at least one of the diaphragm or the exposure time of the first image capturing section 210a and the second image capturing section 210b.

As described above, the monitoring apparatus 110 can adjust the image capturing condition for another camera 112 to the image capturing condition for the camera being capable of appropriately capturing the important subject as the monitoring target. Therefore, the monitoring apparatus 110 can generate unified frame images.

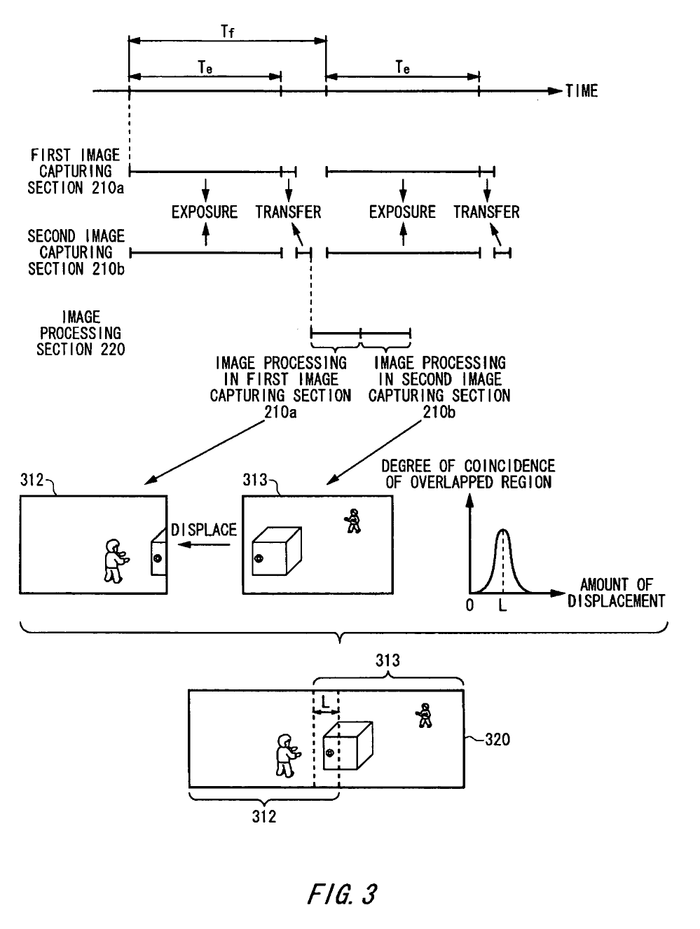

FIG. 3 shows an example of an image capturing process in a monitoring region by the monitoring apparatus 110. The monitoring apparatus 110 acquires a frame image by a predetermined frame period Tf. At this time, the image capturing section 210a and the image capturing section 210b are exposed for a predetermined exposure time Te, and a charge for the quantity of light is accumulated in the first image capturing section 210a and the second image capturing section 210b. Then, the first image capturing section 210a and the second image capturing section 210b sequentially transfer the accumulated charge to the gain control section 222 of the image processing section 220 after the exposure period. Then, the image processing section 220 generates a first frame image 312 in the first monitoring region based on the charge transferred from the first image capturing section 210a and stores the same in a memory 228. Then, the image processing section 220 generates a second frame image 313 in the second monitoring region based on the charge transferred from the second image capturing section 210b and stores the same in the memory 228. Here, the image processing section 220 may store the data transferred from the first image capturing section 210a to the gain control section 222 in the memory 228 once at the time at which the AD converting section 224 converts the data to digital data, and then, start to transfer the data from the second image capturing section 210b to the gain control section 222 before the image data converting section 226 performs an image processing on the data from the first image capturing section 210a.

Then, the overlapped monitoring region identifying section 230 calculates the degree of coincidence of the images in the image region in which each frame image is overlapped at the position at which a second frame image 313 is displaced to a first frame image 312. Then, the overlapped monitoring region identifying section 230 calculates the degree of coincidence of the images for each predetermined amount of displacement.

For example, the overlapped monitoring region identifying section 230 displaces the end of the second frame image 313 to the longitudinal direction in the longitudinal direction of the first frame image 312. Then, the overlapped monitoring region identifying section 230 matches the images in the overlapped image region to calculate the degree of matching of the images as the degree of coincidence of the frame images. Here, the degree of matching of the images may be a value based on the ratio between the area for the objects included in the image region in which each frame image is overlapped and the area for the image region. Additionally, the degree of matching of the image may be a value based on the average value of the luminance for each pixel in the differential image in the image region in which the frame images are overlapped each other.

Then, the overlapped monitoring region identifying section 230 calculates an amount of displacement L indicative of the maximum degree of coincidence. Then, the overlapped monitoring region identifying section 230 identifies the overlapped monitoring region based on the direction to which the image is displaced and the amount of displacement L. Hereinbefore, it has been described that the first frame image is displaced to the longitudinal direction in order to identify the overlapped monitoring region for ease of explanation. However, the direction to which the second frame image is displaced is not limited to the longitudinal direction, of course. For example, the overlapped monitoring region identifying section 230 may calculate the overlapped monitoring region by displacing the second frame image for each of the predetermined amount of displacement along any direction such as the longitudinal direction or the lateral direction of the first frame image. Additionally, the subject positional change calculating section 204 may identify the overlapped image region by coincidentally changing the predetermined amount of displacement in the different two directions such as the longitudinal direction and the lateral direction of the first frame image, respectively.

Then, the monitoring region position calculating section 232 calculates the relative coordinate value between the central coordinate of the image capturing region in the first frame image 312 and the central coordinate of the image capturing region in the second frame image 313 as the relative positional relationship based on the overlapped monitoring region calculated by the overlapped monitoring region identifying section 230. Additionally, the monitoring region position calculating section 232 may calculate the relative coordinate value between the coordinate for each of the opposite corners of the rectangle region captured in the first frame image 312 and the coordinate for each of the opposite corners of the rectangle region captured by the second frame image 313 as the relative positional relationship between the first monitoring region and the second monitoring region.

Then, the monitoring region position storage section 234 stores the relative positional relationship between the first monitoring region and the second monitoring region calculated by the monitoring region position calculating section 232. Here, the above described relative position calculating process may be performed every time a frame image is captured, and also may be regularly performed by a predetermined period. Additionally, the relative position calculating process may be performed when the monitoring apparatus 110 is installed. Additionally, the monitoring apparatus 110 may regularly calculate the relative positional relationship between the first monitoring region and the second monitoring region based on each of the captured frame images, and compare the calculated positional relationship with the relative positional relationship between the first monitoring region and the second monitoring region stored in the monitoring region position storage section 234. Then, the monitoring apparatus 110 may send a massage indicating that the positional relationship stored in the monitoring region position storage section 234 is different from the actual positional relationship when the degree of coincidence between the calculated positional relationship and the positional relationship stored in the monitoring region position storage section 234 is lower than a predetermined value.

Then, the composite image generating section 240 adjusts the position at which the first frame image 312 and the second frame image 313 are combined such that the image regions on which the overlapped monitoring region is shown are not overlapped based on the positional relationship stored in the monitoring region position storage section 234 to generate a composite image 320. As described above, the monitoring system 100 can appropriately combine the images captured by the plurality of cameras 112.

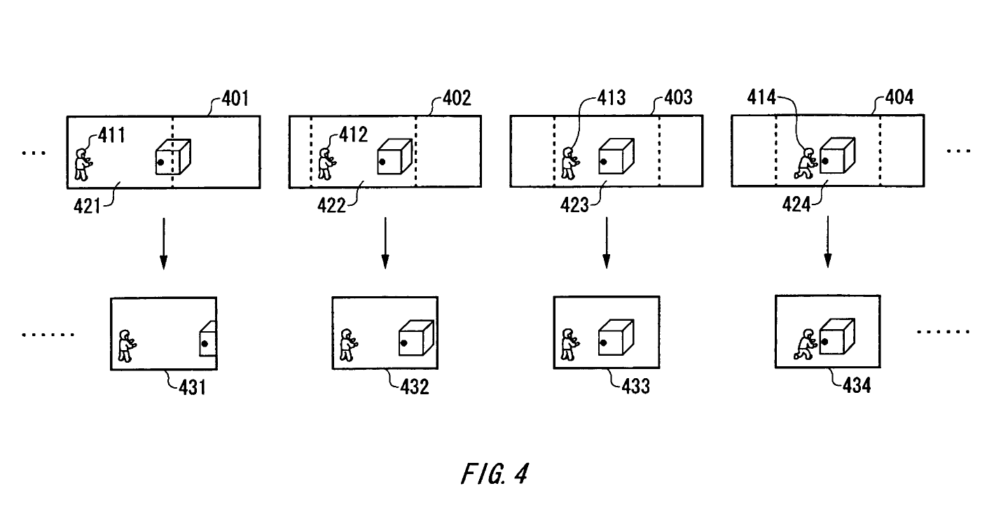

FIG. 4 is an example of a processing to trim a characteristic region image from a composite image by the trimming section 280. The characteristic region identifying section 270 identifies image regions 411, 412, 413 and 414 including moving persons as the characteristic regions from composite images 401, 402, 403 and 404. Then, the trimming section 280 trims characteristic region images 421, 422, 423 and 424 each of which is within one frame moving image including the characteristic regions 411, 412, 413 and 414 as partial monitoring region images, respectively. Then, the moving image storage section 290 stores each of the trimmed partial monitoring region images as frame images 431, 432, 433 and 434 for the moving images to be transmitted to the image reproducing apparatus 120.

Here, the characteristic region identifying section 270 may extract the outline of the subject by performing an image processing such as an edge extraction on the frame image and matches the extracted outline of the subject with the pattern of a predetermined person to identify the image region including the person. Additionally, the characteristic region identifying section 270 may calculate the movement of the subject bases on the position on the image of the subject included in the plurality of frame images which are continuously captured.

Here, the trimming section 280 may trim the partial monitoring region image from the composite image such that a predetermined important monitoring region in the monitoring region 170 is included therein. Additionally, the trimming section 280 may determine the trimming range such that the image region in the direction to which the subject moves is included in the partial monitoring region image when the characteristic region identifying section 270 identifies the moving subject as the characteristic region. Additionally, the trimming section 280 may perform an image processing such as an affine transformation on the trimmed partial monitoring region image when the size of the partial monitoring region image is larger than that of the frame image to fall the partial monitoring region image within the frame image.

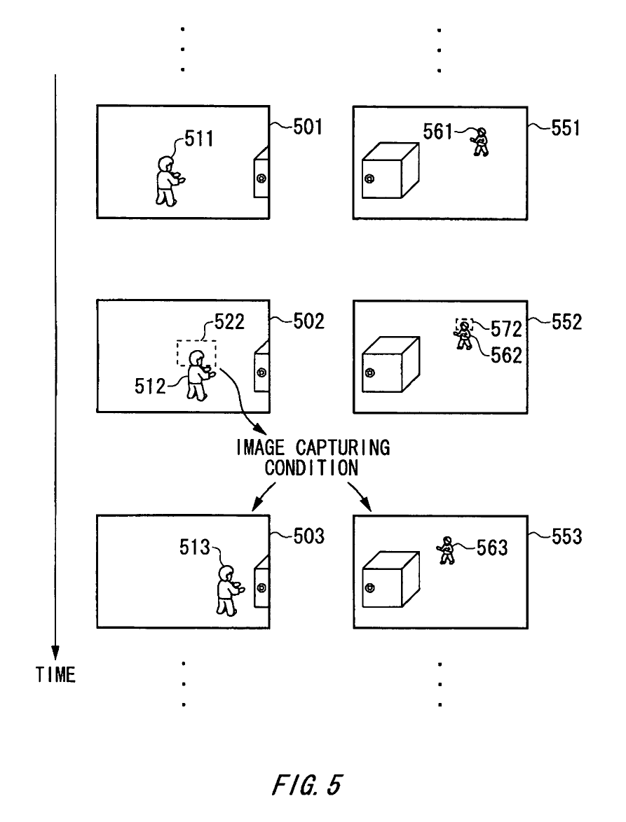

FIG. 5 is an example of a processing to match an image capturing condition for the first image capturing section 210a and the second image capturing section 210b. The first image capturing section 210a captures first frame images 501, 502, and 503. The second image capturing section 210b captures second frame images 551, 552 and 553 at a timing the same as the timing at which each of the first frame images is captured, respectively. At this time, the characteristic region identifying section 270 identifies image regions 511 and 512 including moving persons from the first frame images 501 and 502 continuously captured by the first image capturing section 210a as the characteristic regions. Additionally, the characteristic region identifying section 270 identifies image regions 561 and 562 including moving persons from the second frame images 551 and 552 continuously captured by the second image capturing section 210b as the characteristic regions.

Then, the image capturing condition determining section 272 matches the image capturing condition for the second image capturing section 210b with the image capturing condition for capturing the frame image 503 by the first image capturing section 210a which has captured the frame image 502 including the largest characteristic region 512 among the first frame image 502 and the second frame image 552 captured at the timing before each frame image is captured to acquire the second frame image 553 when the first frame image 503 and the second frame image 553 are captured.

Then, the characteristic region identifying section 270 identifies facial regions 522 and 572 by extracting a fresh color region in the characteristic region when the characteristic region identifying section 270 identifies the characteristic regions 512 and 562 including a person. Then, the facial region brightness judgment section 252 calculates the brightness of the images in the facial regions 522 and 572 based on the average value of the luminance for each pixel in the facial regions 522 and 572. Then, the characteristic region identifying section 270 matches the image capturing condition for the second capturing section 210b with the image capturing condition for the first image capturing section 210a which captures the frame image e.g. the first frame image 502 including the facial region with the brightest calculated e.g. the facial region 522. At this time, the image capturing condition determining section 272 may set the image capturing condition including an exposure condition for which the first image capturing section 210a can appropriately capture the subject in the facial region 522.

When the frame images 503 and 553 will be captured, the image capturing condition determining section 272 matches the image capturing condition for the second image capturing section 210b with the image capturing condition for capturing the frame image 503 by the first image capturing section 210a which has captured the frame image 502 for the characteristic regions 511 and 512 more dynamically moving among the plurality of frame images such as the first frame images 501 and 551 and the second frame images 502 and 552 before the frame images 503 and 553 are captured to capture the frame image 553 by the second image capturing section 210b.

Here, the image capturing condition determining section 272 may store subject characteristic information indicative of such as a shape of the subject included in the region identified as the characteristic region at the earliest timing in association with a characteristic region image capturing timing at which the subject is captured, and match the image capturing condition for the second image capturing section 210b with the image capturing condition for the first image capturing section 210a under which the subject corresponding to the subject characteristic information stored in association with the earliest characteristic region image capturing timing is captured. Thereby the monitoring apparatus 110 captures under the image capturing condition for capturing the person who firstly breaks into the monitoring region 170, so that the monitoring system 110 can appropriately monitor the person.

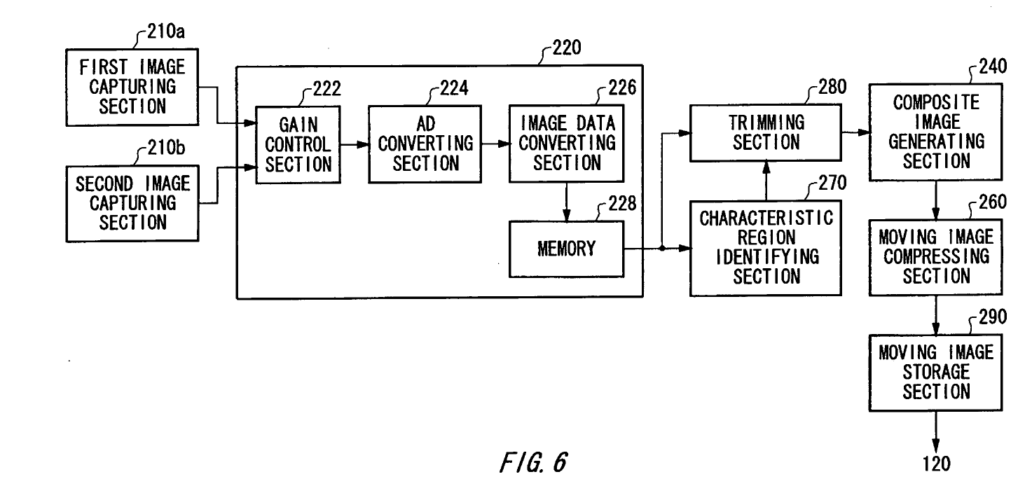

FIG. 6 is a block diagram of the operation of the monitoring apparatus 110 in a connecting mode. In the connecting mode in the present embodiment, the monitoring apparatus 110 includes a first image capturing section 210a, a second image capturing section 210b, an image processing section 220, a composite image generating section 240, a moving image compressing section 260, a characteristic region identifying section 270, a trimming section 280 and a moving image storage section 290. The image processing section 220 includes a gain control section 222, an AD converting section 224, an image data converting section 226 and a memory 228. The components for each of the first image capturing section 210a, the second image capturing section 210b and the image processing section 220 have the operation and the function the same as the components having the same reference numerals in FIG. 2, so that the description is omitted. Here, when a frame image is generated in the connecting mode of the present embodiment, the image capturing condition for capturing by the first image capturing section 210a and the second image capturing section 210b may be set for each of the image capturing sections.

The characteristic region identifying section 270 identifies the characteristic region in the whole monitoring region 170 including the first monitoring region and the second monitoring region based on the moving images captured by the first image capturing section 210a and the second image capturing section 210b, respectively. Specifically, the characteristic region identifying section 270 identifies the characteristic region based on the first frame image and the second frame image converted to digital data by the AD converting section 224. More specifically, the characteristic region identifying section 270 identifies the characteristic region based on the first frame image and the second frame image converted to display image data by the image data converting section 226.

Then, the trimming section 280 trims the plurality of characteristic region images including the plurality of characteristic regions identified by the characteristic region identifying section 270 from the first frame image or the second frame image constituting the moving image captured by the first image capturing section 210a or the second image capturing section 210b, respectively and extracts the same. Then, the composite image generating section 240 generates a composite image obtained by combining the plurality of characteristic region images extracted by the trimming section 280.

Then, the moving image storage section 290 stores the composite image generated by the composite image generating section 240 as the frame image constituting the moving image of the partial monitoring region including at last a part of the first monitoring region and the second monitoring region. Therefore, even if an important monitoring target is located in any region other than the first monitoring region captured by the first image capturing section 210a, the plurality of monitoring targets can be fallen within one frame image and sent to the image reproducing apparatus 120.

The characteristic region identifying section 270 identifies the moving region as the characteristic region based on the moving images captured by the first image capturing section 210a and the second image capturing section 210b, respectively. Then, the trimming section 280 trims the moving region image being an image including the plurality of moving regions identified by the characteristic region identifying section 270 from the first frame image or the second frame image constituting the moving image captured by the first image capturing section 210a or the second image capturing section 210b and extracts the same.

The characteristic region identifying section 270 identifies a personal region in which a person is located as the characteristic region based on the moving images captured by the first image capturing section 210a and the second image capturing section 210b, respectively. Then, the trimming section 280 trims the personal region image being an image including the plurality of personal regions identified by the characteristic region identifying section 270 from the first frame image or the second frame image constituting the moving image captured by the first image capturing section 210a or the second image capturing section 210b and extracts the same.

The trimming section 280 trims the characteristic region image including the characteristic region identified by the characteristic region identifying section 270 such that the aspect ratio of the composite image generated by the composite image generating section 240 is equal to that of the first frame image captured by the first image capturing section 210a or the second frame image captured by the second image capturing section 210b and extracts the same. The trimming section 280 may trim the characteristic region image including the characteristic region identified by the characteristic region identifying section 270 such that the aspect ratio of the composite image generated by the composite image generating section 240 is equal to that of the frame image constituting the moving image reproduced by an external image reproducing apparatus 120 and extract the same. Then, the moving image storage section 290 stores the partial monitoring region image extracted by the trimming section 280 as the frame image constituting the moving image of the partial monitoring region.

The moving image compressing section 260 compresses the plurality of characteristic region images extracted by the trimming section 280 as the frame images constituting the moving image. For example, the moving image compressing section 260 compresses the plurality of partial monitoring region images based on the MPEG standard. Then, the moving image storage section 290 stores the plurality of characteristic region images compressed by the moving image compressing section 260 as the frame image constituting the moving image in the partial monitoring region.

Here, even if the monitoring apparatus 110 generates the frame image in the connecting mode, the trimming section 280 may trim with the aspect ratio equal to the aspect ratio for the case that the frame image is trimmed from the composite image in the trimming mode. Thereby even if the operation mode to generate the frame image is changed in terms of time between the trimming mode and the connecting mode, the aspect ratio is not changed, so that a viewer can easily view the monitoring image.

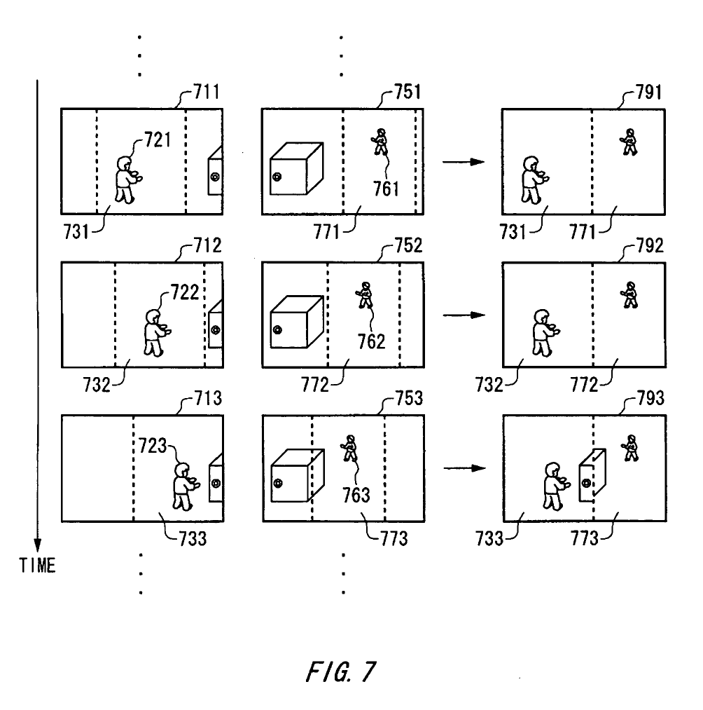

FIG. 7 shows an example of a frame image generated by the monitoring apparatus 110 in the connecting mode. The characteristic region identifying section 270 identifies characteristic regions 721, 722 and 723 for each of first frame images 711, 712 and 713 captured by the first image capturing section 210a. Additionally, the characteristic region identifying section 270 identifies characteristic regions 761, 762 and 763 for each of second frame images 751, 752 and 753 captured by the second image capturing section 210b. Here, a method for identifying the characteristic region by the characteristic region identifying section 270 is the same as the method described with reference to FIG. 4, so that the description is omitted.

Then, the trimming section 280 trims characteristic region images 731 and 771 including a characteristic region 721 included in the first frame image 711 and a characteristic region 761 included in a second frame image 751. At this time, the trimming section 280 may trim the characteristic region images 731 and 771 such that the aspect ratio of the characteristic region images 731 and 771 is equal to the aspect ratio of the moving image displayed by the image reproducing apparatus 120. Here, the trimming section 280 may trim larger image region including the characteristic region when the size of the characteristic region is larger. Additionally, the trimming section 280 may trim the image region including a monitoring region in the direction to which a subject moves when the characteristic region identifying section 270 identifies the moving subject as the characteristic region. Further, when the characteristic region identifying section 270 identifies the moving subject as the characteristic region, the trimming section 280 may trim larger image region including the characteristic region provided that the moving speed is higher. Further, when the characteristic region identifying section 270 identifies the moving subject as the characteristic region, the trimming section 280 may trim larger image region including the characteristic region provided that the ratio between the size of the subject and the moving speed is larger.

Here, when the size of the image obtained by connecting the plurality of characteristic region images is larger than the size of the moving image reproduced by the image reproducing apparatus 120, the trimming section 280 may perform an image processing such as an affine transformation on each of the trimmed characteristic region images in order to fall the connected image within the reproduced moving image.

As described above, the monitoring apparatus 110 generates frame images in the connecting mode, so that a predetermined monitoring target region such as a cash box and an intruder into the monitoring region 170 can be fallen within the same frame image. Therefore, the monitoring system 100 can reduce the amount of data of the moving image transmitted from the monitoring apparatus 110.

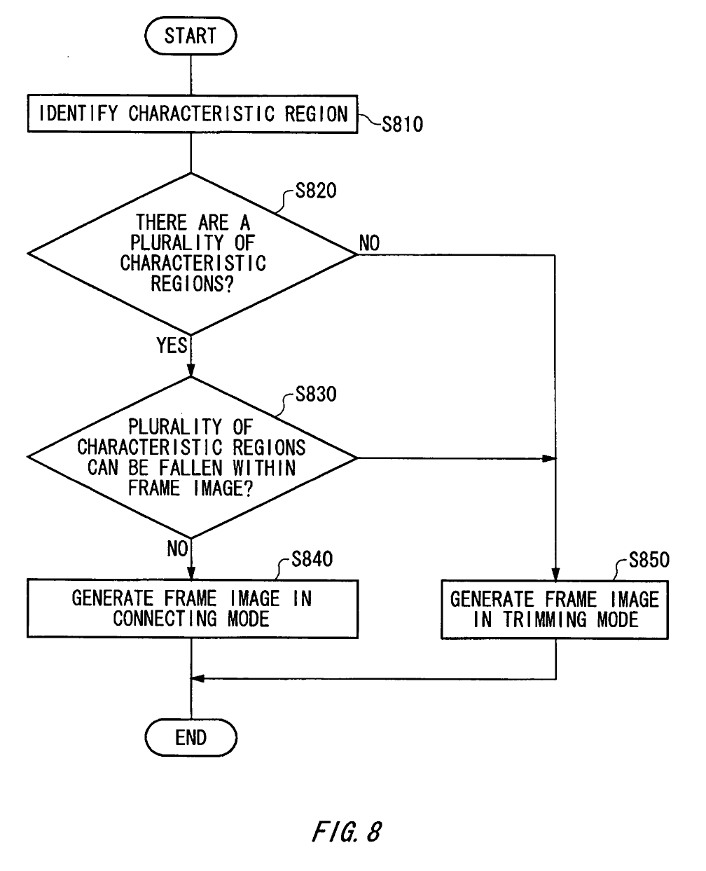

FIG. 8 is a flow chart to select the operation mode to generate a frame image by the monitoring apparatus 110. The characteristic region identifying section 270 identifies a characteristic region from each image captured by the first image capturing section 210a and the second image capturing section 210b at the same timing (S810). Then, the monitoring apparatus 110 judges whether the characteristic region identifying section 270 identifies a plurality of characteristic regions (S820). When the characteristic region identifying section 270 identifies the plurality of characteristic regions in the S820, the monitoring apparatus 110 judges whether the plurality of characteristic regions identified by the characteristic region identifying section 270 can be fallen within the partial monitoring image with the aspect ratio which is trimmed by the trimming section 280 (S830).

When the plurality of characteristic regions identified by the characteristic region identifying section 270 can be fallen within the partial monitoring image with the aspect ratio which is trimmed by the trimming section 280 in the S830, a composite image is generated in the connecting mode (S840). Meanwhile, when the characteristic region identifying section 270 does not identify a plurality of characteristic regions, or the plurality of characteristic regions identified by the characteristic region identifying section 270 can not be fallen within the partial monitoring image with the aspect ratio which is trimmed by the trimming section 280, a composite image is generated in the trimming mode (S850). As described above, the monitoring apparatus 110 can appropriately select the trimming mode or the connecting mode dependent on the position and range at/for which the important monitoring target in the monitoring region 170 is located.

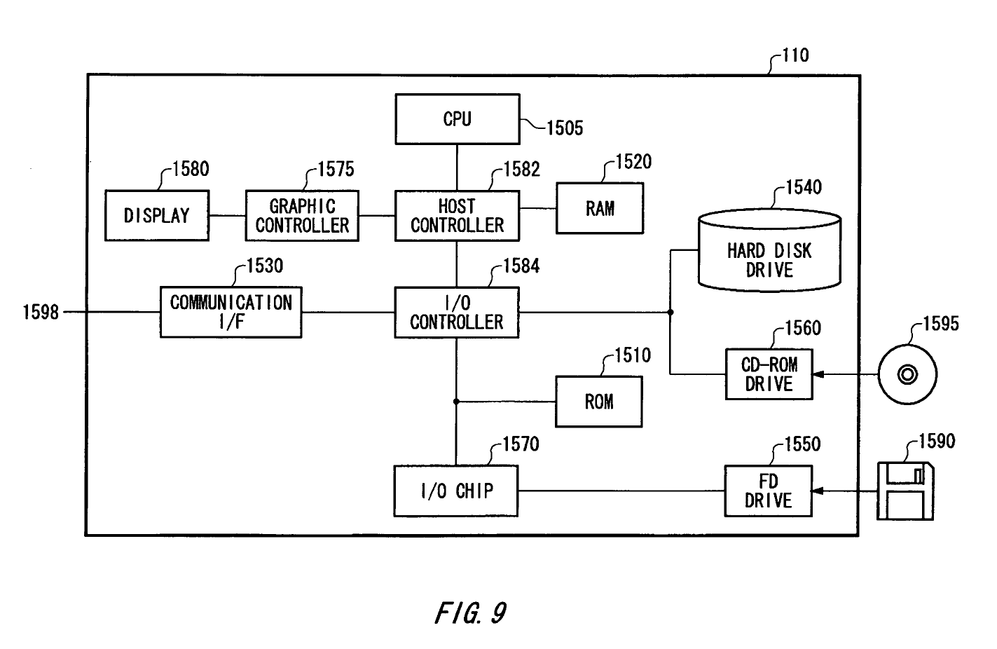

FIG. 9 shows an example of the hardware configuration of the monitoring apparatus 100 according to the present embodiment. The monitoring apparatus 110 includes a CPU periphery having a CPU 1505, a RAM 1520, a graphic controller 1575 and a display 1580 which are connected through a host controller 1582 each other, an input/output unit having a communication interface 1530, a hard disk drive 1540 and a CD-ROM drive 1560 which are connected to the host controller 1582 through an input/output controller 1584 and a legacy input/output unit having a ROM 1510, a flexible disk drive 1550 and an input/output chip 1570 which are connected to the input/output controller 1584.

The host controller 1582 connects the RAM 1520 to the CPU 1505 and the graphic controller 1575 which access the RAM 1520 with a high transfer rate. The CPU 1505 operates according to the programs stored in the ROM 1510 and the RAM 1520 to control each unit. The graphic controller 1575 obtains image data generated on a frame buffer provided in the RAM 1520 by the CPU 1505 and displays the same on the display 1580. Alternatively, the graphic controller 1575 may include therein a frame buffer for storing image data generated by the CPU 1505.

The input/output controller 1584 connects the host controller 1582 to the hard disk drive 1540, the communication interface 1530 and the CD-ROM drive 1560 which are relatively high-speed input/output units. The hard disk drive 1540 stores the program and data used by the CPU 1505. The communication interface 1530 is connected to the network communication apparatus 1598 to transmit/receive the program or data. The CD-ROM drive 1560 reads the program or data from the CD-ROM 1595 and provides the same to the hard disk drive 1540 and the communication interface 1530 through the RAM 1520.

The ROM 1510, and the flexible disk drive 1550 and input/output chip 1570 which are relatively low-speed input/output units are connected to the input/output controller 1584. The ROM 1510 stores a boot program executed by the monitoring apparatus 110 at activating and a program depending on the hardware of the monitoring apparatus 110. The flexible disk drive 1550 reads the program or data from a flexible disk 1590 and provides the same to the hard disk drive 1540 and the communication interface 1530 through the RAM 1520. The input/output chip 1570 connects various input/output units through the flexible disk drive 1550 and such as a parallel port, a serial port, a keyboard port and a mouse port.

The program executed by the CPU 1505 is stored in a recording medium, such as the flexible disk 1590, the CD-ROM 1595, or an IC card and provided by the user. The program stored on the recording medium may be compressed and not compressed. The program is installed from the recording medium to the hard disk drive 1540, read by the RAM 1520 and executed by the CPU 1505.

The program executed by the CPU 1505 operates the monitoring apparatus 110 to function as the first image capturing section 210a, the second image capturing section 210b, the image processing section 220, the overlapped monitoring region identifying section 230, the monitoring region position calculating section 232, the monitoring region position storage section 234, the composite image generating section 240, the facial region extracting section 250, the facial region brightness judgment section 252, the moving image compressing section 260, the characteristic region identifying section 270, the image capturing condition determining section 272, the image capturing controlling section 274, the trimming section 280 and the moving image storage section 290 described with reference to FIG. 1-FIG. 8. Additionally, the program executed by the CPU 1505 operates the image processing section 220 to function as the gain control section 222, the AD converting section 224, the image data converting section 226 and the memory 228 described with reference to FIG. 1-FIG. 8.

The above-described programs may be stored in an external storage medium. The recording medium may be, in addition to the flexible disk 1590 and the CD-ROM 1595, an optical storage medium such as a DVD and a PD, a magneto-optical recording medium such as a MD, a tape medium and a semiconductor memory such as an IC card. Additionally, a storage medium such as a hard disk or a RAM which is provided in the server system connected to a private communication network or Internet is used as the recording medium to provide the program to the monitoring apparatus 110 through the network.

While the present invention have been described with the embodiment, the technical scope of the invention not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

What is claimed is:

1. A monitoring system comprising:
a first image capturing section for capturing a moving image in a first monitoring region;
a second image capturing section for capturing a moving image in a second monitoring region adjacent to the first monitoring region in synchronism with an image capturing operation by the first image capturing section in the first monitoring region;
a composite image generating section for adjusting a position at which a first frame image constituting a moving image captured by the first image capturing section and a second frame image constituting a moving image captured by the second image capturing section are combined based on the relative positional relationship between the first monitoring region captured by the first image capturing section and the second monitoring region captured by the second image capturing section; and
a moving image storage section for storing a composite image generated by the composite image generating section as a frame image constituting the moving image in a partial monitoring region including at least a part of the first monitoring region and the second monitoring region.

2. The monitoring system according to claim 1 further comprising:
an overlapped monitoring region identifying section for matching the first frame image captured by the first image capturing section with the second frame image captured by the second image capturing section at the same time the first image capturing section captures the first frame image to identify an overlapped monitoring region over which the first monitoring region captured by the first image capturing section and the second monitoring region captured by the second image capturing section are overlapped; and
a monitoring region position calculating section for calculating the relative positional relationship between the first monitoring region captured by the first image capturing section and the second monitoring region captured by the second image capturing section based on the overlapped monitoring region identified by the overlapped monitoring region identifying section, wherein
the composite image generating section adjusts the position at which the first frame image and the second frame image are combined based on the relative relationship between the first monitoring region and the second monitoring region calculated by the monitoring region position calculating section to generate the composite image.

3. The monitoring system according to claim 1 further comprising a trimming section for trimming the composite image generated by the composite image generating section with an aspect ratio equal to that of the first frame image captured by the first image capturing section or the second frame image captured by the second image capturing section and extracting the partial monitoring region image, wherein
the moving image storage section stores the partial monitoring region image extracted by the trimming section as the frame image constituting the moving image in the partial monitoring region.

4. The monitoring system according to claim 1 further comprising a trimming section for trimming the composite image generated by the composite image generating section with an aspect ratio equal to that of the frame image constituting the moving image reproduced by an external image reproducing apparatus and extracting the partial monitoring region image, wherein
the moving image storage section stores the partial monitoring region image extracted by the trimming section as the frame image constituting the moving image in the partial monitoring region.

5. The monitoring system according to claim 3 further comprising a moving image compressing section for compressing a plurality of partial monitoring region images extracted by the trimming section as the frame images constituting the moving image, wherein
the moving image storage section stores the plurality of partial monitoring region images compressed by the moving image compressing section as the frame images constituting the moving image in the partial monitoring region.

6. The monitoring system according to claim 4 further comprising a moving image compressing section for compressing a plurality of partial monitoring region images extracted by the trimming section as the frame images constituting the moving image, wherein
the moving image storage section stores the plurality of partial monitoring region images compressed by the moving image compressing section as the frame images constituting the moving image in the partial monitoring region.

7. The monitoring system according to claim 1 further comprising an image processing section for alternately performing an image processing on the first frame image read from a plurality of light receiving elements included in the first image capturing section and the second frame image read from a plurality of light receiving elements included in the second image capturing section and storing the same in a memory.

8. The monitoring system according to claim 6, wherein
the image processing section includes an AD converting section for alternately converting the first frame image read from the plurality of light receiving elements included in the first image capturing section and the second frame image read from the plurality of light receiving elements included in the second image capturing section to digital data, and
the composite image generating section adjusts the position at which the first frame image converted to the digital data by the AD converting section and the second frame image converted to digital data by the AD converting section are combined to generate the composite image.

9. The monitoring system according to claim 6, wherein
the image processing section includes an image data converting section for alternately converting image data for the first frame image read from the plurality of light receiving elements included in the first image capturing section and the image data for the second frame image read from the plurality of light receiving elements included in the second image capturing section to display image data,
the composite image generating section adjusts the position at which the first frame image converted to the display image data by the image data converting section and the second frame image converted to the display image data by the image data converting section to generate the composite image.

10. The monitoring apparatus comprising:
a first image capturing section for capturing a moving image in a first monitoring region;
a second image capturing section for capturing a moving image in a second monitoring region adjacent to the first monitoring region in synchronism with an image capturing operation by the first image capturing section in the first monitoring region;
a composite image generating section for adjusting a position at which a first frame image constituting a moving image captured by the first image capturing section and a second frame image constituting a moving image captured by the second image capturing section are combined based on the relative positional relationship between the first monitoring region captured by the first image capturing section and the second monitoring region captured by the second image capturing section to generate a composite image; and
a moving image storage section for storing the composite image generated by the composite image generating section as a frame image constituting the moving image in a partial monitoring region including at least a part of the first monitoring region and the second monitoring region.

11. A monitoring method comprising:
capturing a moving image in a first monitoring region;
capturing a moving image in a second monitoring region adjacent to the first monitoring region in synchronism with an image capturing operation in the first monitoring region in the first image capturing step;
adjusting a position at which a first frame image constituting a moving image captured in the first image capturing step and a second frame image constituting a moving image captured in the second image capturing step are combined based on the relative positional relationship between the first monitoring region captured in the first image capturing step and the second monitoring region captured in the second image capturing step to generate a composite image; and
storing the composite image generated in the composite image generating step as a frame image constituting the moving image in a partial monitoring region including at least a part of the first monitoring region and the second monitoring region.

12. A program for a monitoring system for capturing a moving image, the program operates the monitoring system to function as:
a first image capturing section for capturing a moving image in a first monitoring region;
a second image capturing section for capturing a moving image in a second monitoring region adjacent to the first monitoring region in synchronism with an image capturing operation by the first image capturing section in the first monitoring region;
a composite image generating section for adjusting a position at which a first frame image constituting a moving image captured by the first image capturing section and a second frame image constituting a moving image captured by the second image capturing section are combined based on the relative positional relationship between the first monitoring region captured by the first image capturing section and the second monitoring region captured by the second image capturing section; and
a moving image storage section for storing a composite image generated by the composite image generating section as a frame image constituting the moving image in a partial monitoring region including at least a part of the first monitoring region and the second monitoring region.
